(19) United States
(12) Patent Application Publication
(10) Pub. No.: US 2009/0292992 A1
(43) Pub. Date: Nov. 26, 2009

(54) COMPUTER SYSTEM AND A SWITCHING METHOD FOR THE SAME

(75) Inventors: Wen-Chi CHENG, Taipei-Hsien (TW); Chung-Wen Chen, Taipei-Hsien (TW)

Correspondence Address: LADAS & PARRY, 5670 WILSHIRE BOULEVARD, SUITE 2100, LOS ANGELES, CA, 90036-5679, US

(73) Assignee: MICRO-STAR INTERNATIONAL CO., LTD, Jung-He City (TW)

(21) Appl. No.: 12/512,905

(22) Filed: Jul. 30, 2009

Related U.S. Application Data
(63) Continuation-in-part of application No. 11/096,332, filed on Mar. 30, 2005.

(30) Foreign Application Priority Data
Apr. 8, 2004 (TW) 093109678

(51) Int. Cl. G06F 1/26; G06F 17/00; G06F 3/048

(52) U.S. Cl. 715/718; 700/94; 700/295

(57) ABSTRACT

A switching method includes: when a control unit receives a first command signal and determines that a host computing device is turned off and a power source is disabled, configuring the control unit to operate a switch unit in a first switch state and to enable the power source, thereby enabling audio and video playback of the host computing device; and when the control unit receives a second command signal and determines that the host computing device is turned off and the power source is disabled, configuring the control unit to operate the switch unit in a second switch state and to enable the power source, thereby enabling audio and video playback of an audio-and-video reproducing device. A computer system that includes the control unit, the host computing device, the power source, the switch unit, and the audio-and-video reproducing device is also disclosed.

### CROSS-REFERENCE TO RELATED APPLICATIONS

This application is a continuation-in-part of U.S. patent application Ser. No. 11/096,332, filed on Mar. 30, 2005, which claims priority of Taiwanese Application No. 093109678, filed on Apr. 8, 2004, both of which are incorporated herein in their entirety.

### BACKGROUND OF THE INVENTION

1. Field of the Invention

The invention relates to computer systems and switching methods for the same.

2. Description of the Related Art

In U.S. Pat. No. 6,266,714, there is disclosed a conventional computer system that includes an optical disc drive, a computing device, and a playback device. The optical disc drive is operable so as to read information stored in an optical disc. The computing device is installed with an operating system. The playback device is operable so as to reproduce the information read by the optical disc drive when the computing device is turned off.

The aforementioned conventional computer system is disadvantageous in that only information stored in audio compact discs can be reproduced when the computing device is turned off.

### SUMMARY OF THE INVENTION

Therefore, an object of the present invention is to provide a computer system that can overcome the aforesaid drawback of the prior art.

Another object of the present invention is to provide a switching method that enables audio and video playback of either a host computing device or an audio-and-video reproducing device of the computer system.

According to a first aspect of the present invention, a computer system comprises a reading device, a power source, a host computing device, an audio-and-video reproducing device, a switch unit, and a control unit. The reading device is operable so as to read information from a storage medium. The switch unit is coupled to the reading device, the power source, the host computing device, and the audio-and-video reproducing device. The switch unit is operable in a first switch state, where the switch unit connects the reading device and the power source to the host computing device and simultaneously disconnects the reading device and the power source from the audio-and-video reproducing device, and a second switch state, where the switch unit connects the reading device and the power source to the audio-and-video reproducing device and simultaneously disconnects the reading device and the power source from the host computing device. The host computing device is turned on and is operable so as to convert the information read by the reading device into audio and video output signals when the switch unit is in the first switch state and when the power source is enabled. The audio-and-video reproducing device is turned on and is operable so as to convert the information read by the reading device into audio and video output signals when the switch unit is in the second switch state and when the power source is enabled. The control unit is coupled to the power source, the host computing device, and the switch unit. When the control unit receives a first command signal and determines that the host computing device is turned off and the power source is disabled, the control unit is configured to operate the switch unit in the first switch state and to enable the power source. When the control unit receives a second command signal and determines that the host computing device is turned off and the power source is disabled, the control unit is configured to operate the switch unit in the second switch state and to enable the power source. When the control unit receives the second command signal and determines that the host computing device is turned on, the control unit is configured to ignore the second command signal.

According to a second aspect of the present invention, a computer system comprises a reading device, a power source, a host computing device, an audio-and-video reproducing device, a switch unit, and a control unit. The reading device is operable so as to read information from a storage medium. The host computing device has a power management function which when actuated causes the host computing device to operate in a soft-off state. The switch unit is coupled to the reading device, the power source, the host computing device, and the audio-and-video reproducing device. The switch unit is operable in a first switch state, where the switch unit connects the reading device and the power source to the host computing device and simultaneously disconnects the reading device and the power source from the audio-and-video reproducing device, and a second switch state, where the switch unit connects the reading device and the power source to the audio-and-video reproducing device and simultaneously disconnects the reading device and the power source from the host computing device. The host computing device is turned on and is operable so as to convert the information read by the reading device into audio and video output signals when the switch unit is in the first switch state and when the power source is enabled. The audio-and-video reproducing device is turned on and is operable so as to convert the information read by the reading device into audio and video output signals when the switch unit is in the second switch state and when the power source is enabled. The control unit is coupled to the power source, the host computing device, and the switch unit. When the control unit receives a first command signal and determines that the host computing device is turned off and the power source is disabled, the control unit is configured to operate the switch unit in the first switch state and to enable the power source. When the control unit receives a second command signal and determines that the host computing device is turned off and the power source is disabled, the control unit is configured to operate the switch unit in the second switch state and to enable the power source. When the control unit receives the second command signal and determines that the host computing device is turned on, the control unit is configured to actuate the power management function of the host computing device and to operate the switch unit in the second switch state.

According to a third aspect of the present invention, there is provided a switching method for a computer system that includes a reading device, a power source, a host computing device, an audio-and-video reproducing device, a switch unit, and a control unit. The switch unit is operable in a first switch state, where the switch unit connects the reading device and the power source to the host computing device and simultaneously disconnects the reading device and the power source from the audio-and-video reproducing device, and a second switch state, where the switch unit connects the reading device and the power source to the audio-and-video reproducing device and simultaneously disconnects the reading device and the power source from the host computing device. The switching method comprises:

A) configuring the control unit to determine whether a first command signal or a second command signal is received;

B) when it is determined in step A) that the first command signal is received, configuring the control unit to determine whether the host computing device is turned on or off;

C) when it is determined in step B) that the host computing device is turned off, configuring the control unit to determine whether the power source is enabled or disabled;

D) when it is determined in step C) that the power source is disabled, configuring the control unit to operate the switch unit in the first switch state and to enable the power source, wherein the host computing device is turned on and is operable so as to convert information read by the reading device into audio and video output signals when the switch unit is in the first switch state and when the power source is enabled;

E) when it is determined in step A) that the second command signal is received, configuring the control unit to determine whether the host computing device is turned on or off;

F) when it is determined in step E) that the host computing device is turned off, configuring the control unit to determine whether the power source is enabled or disabled;

G) when it is determined in step F) that the power source is disabled, configuring the control unit to operate the switch unit in the second switch state and to enable the power source, wherein the audio-and-video reproducing device is turned on and is operable so as to convert information read by the reading device into audio and video output signals when the switch unit is in the second switch state and when the power source is enabled; and

H) when it is determined in step E) that the host computing device is turned on, configuring the control unit to ignore the second command signal.

According to a fourth aspect of the present invention, there is provided a switching method for a computer system that includes a reading device, a power source, a host computing device, an audio-and-video reproducing device, a switch unit, and a control unit. The switch unit is operable in a first switch state, where the switch unit connects the reading device and the power source to the host computing device and simultaneously disconnects the reading device and the power source from the audio-and-video reproducing device, and a second switch state, where the switch unit connects the reading device and the power source to the audio-and-video reproducing device and simultaneously disconnects the reading device and the power source from the host computing device. The switching method comprises:

A) configuring the control unit to determine whether a first command signal or a second command signal is received;

B) when it is determined in step A) that the first command signal is received, configuring the control unit to determine whether the host computing device is turned on or off;

C) when it is determined in step B) that the host computing device is turned off, configuring the control unit to determine whether the power source is enabled or disabled;

D) when it is determined in step C) that the power source is disabled, configuring the control unit to operate the switch unit in the first switch state and to enable the power source, wherein the host computing device is turned on and is operable so as to convert information read by the reading device into audio and video output signals when the switch unit is in the first switch state and when the power source is enabled;

E) when it is determined in step A) that the second command signal is received, configuring the control unit to determine whether the host computing device is turned on or off;

F) when it is determined in step E) that the host computing device is turned off, configuring the control unit to determine whether the power source is enabled or disabled;

G) when it is determined in step F) that the power source is disabled, configuring the control unit to operate the switch unit in the second switch state and to enable the power source, wherein the audio-and-video reproducing device is turned on and is operable so as to convert information read by the reading device into audio and video output signals when the switch unit is in the second switch state and when the power source is enabled; and

H) when it is determined in step E) that the host computing device is turned on, configuring the control unit to actuate a power management function of the host computing device, which causes the host computing device to operate in a soft-off state, and to operate the switch unit in the second switch state.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic circuit block diagram of the preferred embodiment of a computer system according to the present invention;

FIG. 2 is a schematic view illustrating a remote controller of the preferred embodiment;

FIGS. 3 and 4 are flow charts of the first preferred embodiment of a switching method to be implemented by the computer system shown in FIG. 1 according to this invention; and

FIGS. 5 and 6 are flow charts of the second preferred embodiment of a switching method to be implemented by the computer system shown in FIG. 1 according to this invention.

### DETAILED DESCRIPTION OF THE PREFERRED EMBODIMENTS

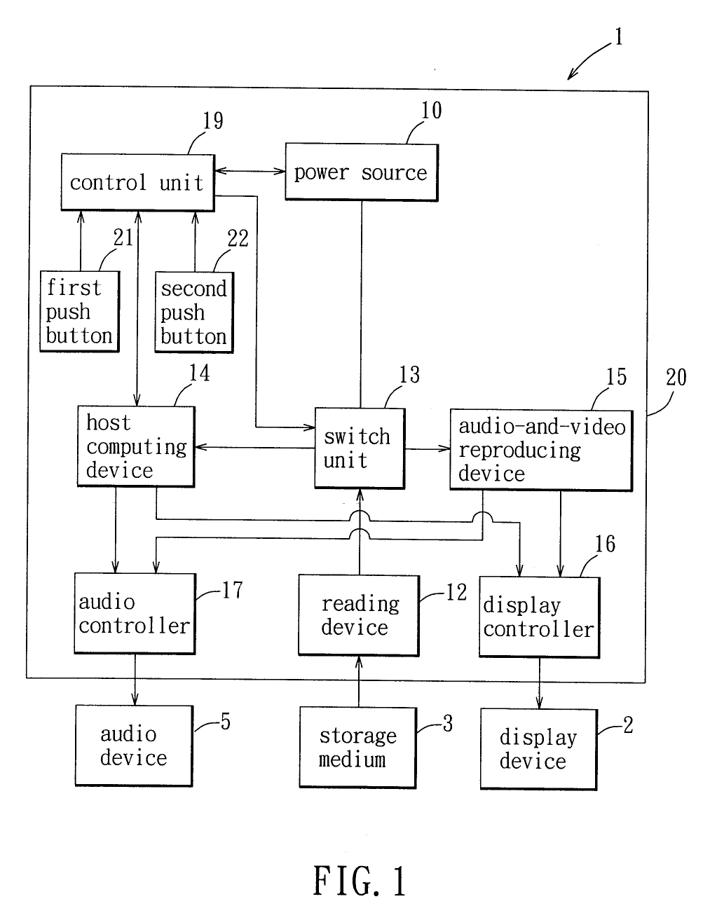

Referring to FIG. 1, the preferred embodiment of a computer system 1 according to this invention is shown to include a reading device 12, a power source 10, a host computing device 14, an audio-and-video reproducing device 15, a switch unit 13, and a control unit 19.

The computer system 1 of this embodiment is a desktop personal computer or a notebook computer.

The reading device 12 is operable so as to read information from a storage medium 3. In this embodiment, the reading device 12 is a DVD drive or a CD-ROM drive, and the storage medium 3 is an optical disc.

In an alternative embodiment, the reading device 12 is a memory card reader, and the storage medium 3 is a memory card, such as a secure digital (SD) memory card or a memory stick (MS) memory card.

The power source 10 is operable so as to supply electrical power and may be enabled or disabled.

The host computing device 14 is installed with an operating system, such as Microsoft Windows, and has a power management function which when actuated causes the host computing device 14 to operate in a soft-off state, i.e., G2 or S5 state. In this embodiment, the power management function complies with an advanced configuration and power interface (ACPI) specification.

The switch unit 13 is connected to the reading device 12, the power source 10, the host computing device 14, and the audio-and-video reproducing device 15. In this embodiment, the switch unit 13 is operable in a first switch state, where the switch unit 13 connects the reading device 12 and the power source 10 to the host computing device 14 and simultaneously disconnects the reading device 12 and the power source 10 from the audio-and-video reproducing device 15, and a second switch state, where the switch unit 13 connects the reading device 12 and the power source 10 to the audio-and-video reproducing device 15 and simultaneously disconnects the reading device 12 and the power source 10 from the host computing device 14. In this embodiment, the switch unit 13 is an electrically controlled switch unit 13.

It is noted that when the switch unit 13 is in the first switch state and when the power source 10 is enabled, the host computing device 14 is turned on and is operable so as to convert the information read by the reading device 12 into audio and video output signals.

It is also noted that when the switch unit 13 is in the second switch state and when the power source 10 is enabled, the audio-and-video reproducing device 15 is turned on and is operable so as to convert the information read by the reading device 12 into audio and video output signals.

The computer system 1 further includes a display controller 16 and an audio controller 17. The display controller 16 is connected to the host computing device 14, the audio-and-video reproducing device 15, and a display device 2, and is operable so as to provide the video output signal generated by the host computing device 14 to the display device 2 when the switch unit 13 is in the first switch state and when the power source 10 is enabled, and so as to provide the video output signal generated by the audio-and-video reproducing device 15 to the display device 2 when the switch unit 13 is in the second switch state and when the power source 10 is enabled. The audio controller 17 is connected to the host computing device 14, the audio-and-video reproducing device 15, and an audio device 5, and is operable so as to provide the audio output signal generated by the host computing device 14 to the audio device 5 when the switch unit 13 is in the first switch state and when the power source 10 is enabled, and so as to provide the audio output signal generated by the audio-and-video reproducing device 15 to the audio device 5 when the switch unit 13 is in the second switch state and when the power source 10 is enabled.

The control unit 19 is connected to the power source 10, the host computing device 14, and the switch unit 13, and is configured in a manner that will be described hereinafter.

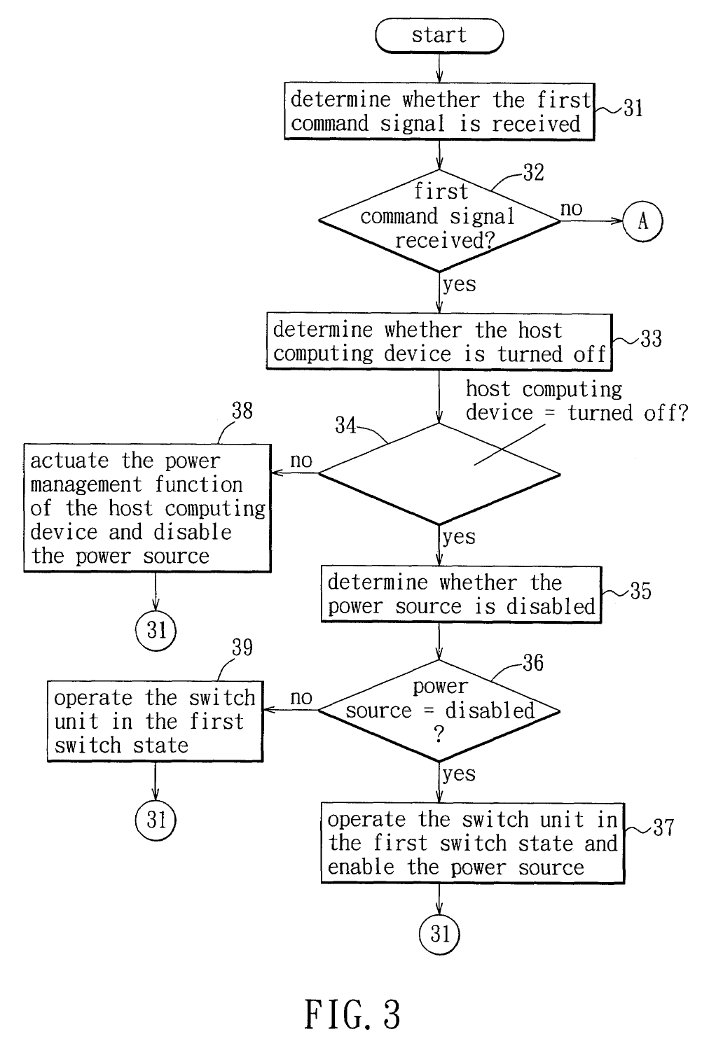

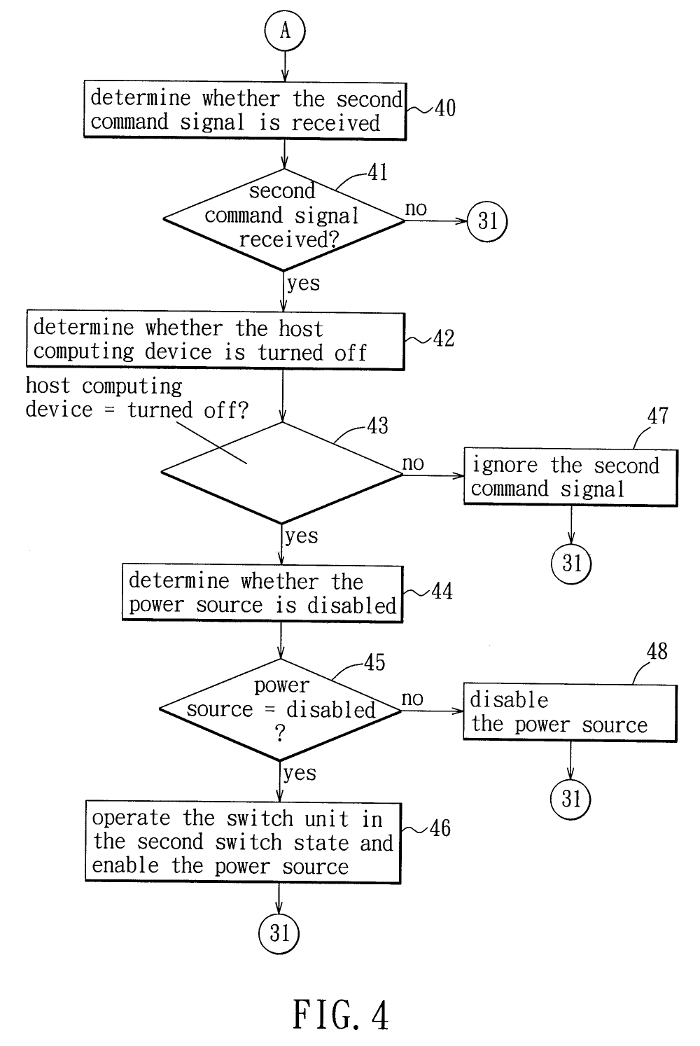

The first preferred embodiment of a switching method to be implemented by the aforementioned computer system 1 according to this invention will now be described with further reference to FIGS. 3 and 4.

In step 31, the control unit 19 is configured to determine whether a first command signal is received.

In step 32, when it is determined in step 31 that the first command signal is received, the flow proceeds to step 33. Otherwise, the flow proceeds to step 40.

In step 33, the control unit 19 is configured to determine whether the host computing device 14 is turned off.

In step 34, when it is determined in step 33 that the host computing device 14 is turned off, the flow proceeds to step 35. Otherwise, the flow proceeds to step 38.

In step 35, the control unit 19 is configured to determine whether the power source 10 is disabled.

In step 36, when it is determined in step 35 that the power source 10 is disabled, the flow proceeds to step 37. Otherwise, the flow proceeds to step 39.

In step 37, the control unit 19 is configured to operate the switch unit 13 in the first switch state and to enable the power source 10. Thereafter, the flow goes back to step 31.

In step 38, the control unit 19 is configured to actuate the power management function of the host computing device 14 and to disable the power source 10, thereby turning off the host computing device 14. Thereafter, the flow goes back to step 31.

In step 39, the control unit 19 is configured to operate the switch unit 13 in the first switch state. Thereafter, the flow goes back to step 31.

In step 40, the control unit 19 is configured to determine whether a second command signal is received.

In step 41, when it is determined in step 40 that the second command signal is received, the flow proceeds to step 42. Otherwise, the flow goes back to step 31.

In step 42, the control unit 19 is configured to determine whether the host computing device 14 is turned off.

In step 43, when it is determined in step 42 that the host computing device 14 is turned off, the flow proceeds to step 44. Otherwise, the flow proceeds to step 47.

In step 44, the control unit 19 is configured to determine whether the power source 10 is disabled.

In step 45, when it is determined in step 44 that the power source 10 is disabled, the flow proceeds to step 46. Otherwise, the flow proceeds to step 48.

In step 46, the control unit 19 is configured to operate the switch unit 13 in the second switch state and to enable the power source 10. Thereafter, the flow goes back to step 31.

In step 47, the control unit 19 is configured to ignore the second command signal. Thereafter, the flow goes back to step 31.

In step 48, the control unit 19 is configured to disable the power source 10, thereby turning off the audio-and-video reproducing device 15. Thereafter, the flow goes back to step 31.

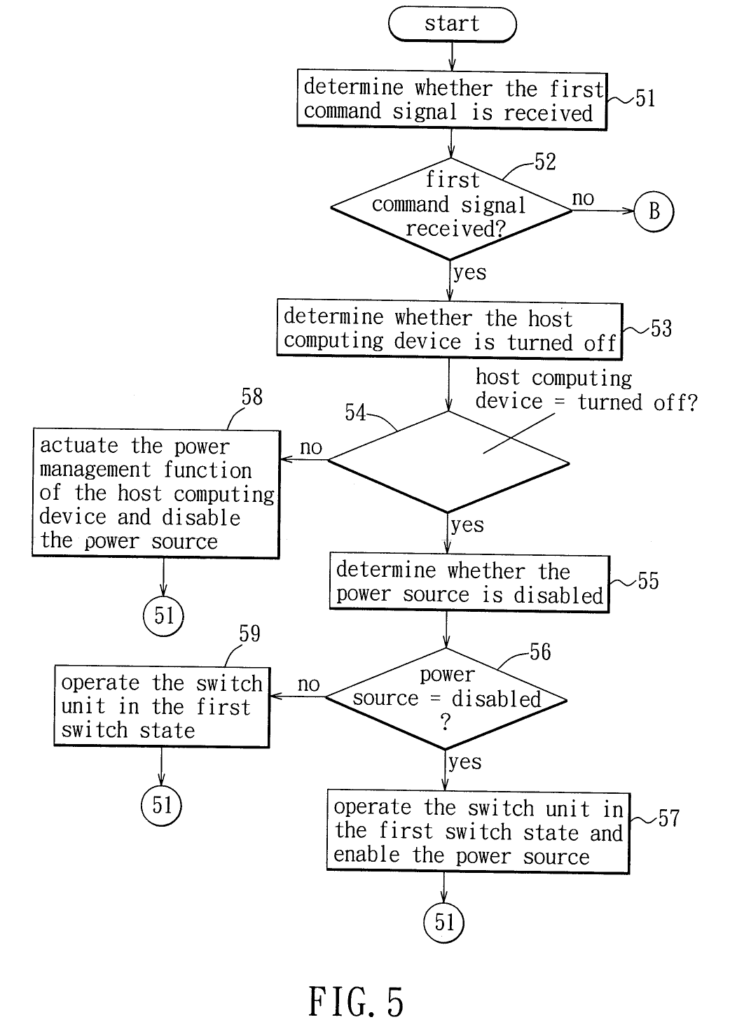

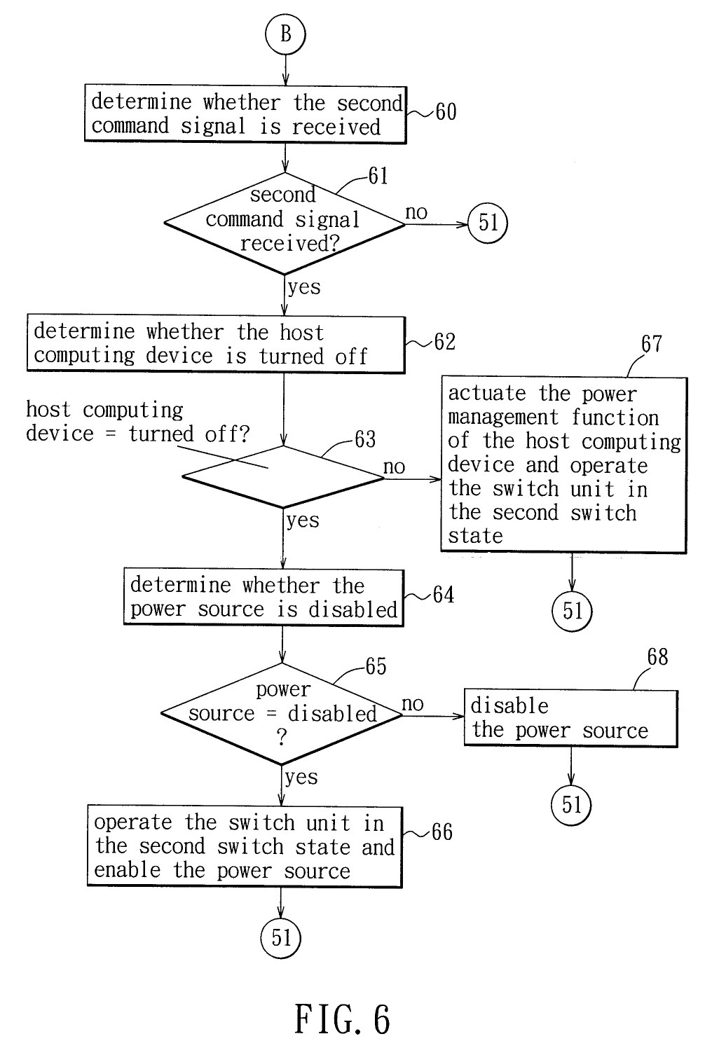

The second preferred embodiment of a switching method to be implemented by the aforementioned computer system 1 according to this invention will now be described with further reference to FIGS. 5 and 6.

In step 51, the control unit 19 is configured to determine whether a first command signal is received.

In step 52, when it is determined in step 51 that the first command signal is received, the flow proceeds to step 53. Otherwise, the flow proceeds to step 60.

In step 53, the control unit 19 is configured to determine whether the host computing device 14 is turned off.

In step 54, when it is determined in step 53 that the host computing device 14 is turned off, the flow proceeds to step 55. Otherwise, the flow proceeds to step 58.

In step 55, the control unit 19 is configured to determine whether the power source 10 is disabled.

In step 56, when it is determined in step 55 that the power source 10 is disabled, the flow proceeds to step 57. Otherwise, the flow proceeds to step 59.

In step 57, the control unit 19 is configured to operate the switch unit 13 in the first switch state and to enable the power source 10. Thereafter, the flow goes back to step 51.

In step 58, the control unit 19 is configured to actuate the power management function of the host computing device 14 and to disable the power source 10, thereby turning off the host computing device 14. Thereafter, the flow goes back to step 51.

In step 59, the control unit 19 is configured to operate the switch unit 13 in the first switch state. Thereafter, the flow goes back to step 51.

In step 60, the control unit 19 is configured to determine whether a second command signal is received.

In step 61, when it is determined in step 60 that the second command signal is received, the flow proceeds to step 62. Otherwise, the flow goes back to step 51.

In step 62, the control unit 19 is configured to determine whether the host computing device 14 is turned off.

In step 63, when it is determined in step 62 that the host computing device 14 is turned off, the flow proceeds to step 64. Otherwise, the flow proceeds to step 67.

In step 64, the control unit 19 is configured to determine whether the power source 10 is disabled.

In step 65, when it is determined in step 64 that the power source 10 is disabled, the flow proceeds to step 66. Otherwise, the flow proceeds to step 68.

In step 66, the control unit 19 is configured to operate the switch unit 13 in the second switch state and to enable the power source 10. Thereafter, the flow goes back to step 51.

In step 67, the control unit 19 is configured to actuate the power management function of the host computing device 14 and to operate the switch unit 13 in the second switch state. Thereafter, the flow goes back to step 51.

In step 68, the control unit 19 is configured to disable the power source 10, thereby turning off the audio-and-video reproducing device 15. Thereafter, the flow goes back to step 51.

The computer system 1 further includes a push button unit that includes first and second push buttons 21, 22, each of which is connected to the control unit 19 and is operable so as to generate a respective one of the first and second command signals.

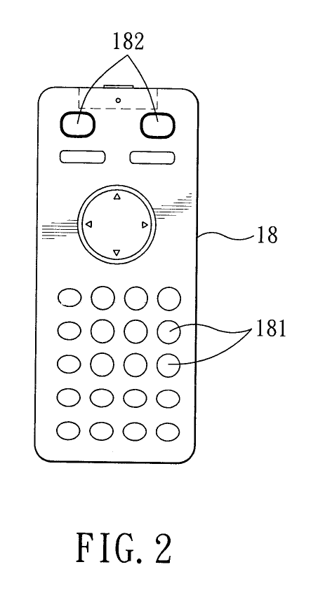

With further reference to FIG. 2, the computer system 1 further includes a remote controller 18 that includes first and second user input units 181, 182. The first user input unit 181 is operable so as to generate a user command signal, which is transmitted wirelessly, for controlling operation (e.g., channel, volume, and playback controls) of the host computing device 14 when the switch unit 13 is in the first switch state and when the power source 10 is enabled, and for controlling operation (e.g., channel, volume, and playback controls) of the audio-and-video reproducing device 15 when the switch unit 13 in the second switch state and the power source 10 is enabled. The second user input unit 182 is operable so as to generate the first or second command signal, which is transmitted wirelessly to the control unit 19. In this embodiment, the remote controller 18 includes one of an infrared device, a radio frequency device, and a Bluetooth device.

The computer system 1 further includes a casing 20 that houses the reading device 12, the power source 10, the host computing device 14, the audio-and-video reproducing device 15, the switch unit 13, the control unit 19, the first and second push buttons 21, 22, the display controller 16, and the audio controller 17.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A computer system, comprising:
a reading device operable so as to read information from a storage medium;
a power source;
a host computing device;
an audio-and-video reproducing device;
a switch unit coupled to said reading device, said power source, said host computing device, and said audio-and-video reproducing device, said switch unit being operable in a first switch state, where said switch unit connects said reading device and said power source to said host computing device and simultaneously disconnects said reading device and said power source from said audio-and-video reproducing device, and a second switch state, where said switch unit connects said reading device and said power source to said audio-and-video reproducing device and simultaneously disconnects said reading device and said power source from said host computing device,
wherein said host computing device is turned on and is operable so as to convert the information read by said reading device into audio and video output signals when said switch unit is in the first switch state and when said power source is enabled, and
wherein said audio-and-video reproducing device is turned on and is operable so as to convert the information read by said reading device into audio and video output signals when said switch unit is in the second switch state and when said power source is enabled; and
a control unit coupled to said power source, said host computing device, and said switch unit,
wherein when said control unit receives a first command signal and determines that said host computing device is turned off and said power source is disabled, said control unit is configured to operate said switch unit in the first switch state and to enable said power source,
wherein when said control unit receives a second command signal and determines that said host computing device is turned off and said power source is disabled, said control unit is configured to operate said switch unit in the second switch state and to enable said power source, and
wherein when said control unit receives the second command signal and determines that said host computing device is turned on, said control unit is configured to ignore the second command signal.

2. The computer system as claimed in claim 1, wherein:
said host computing device has a power management function which when actuated causes said host computing device to operate in a soft-off state; and
when said control unit receives the first command signal and determines that said host computing device is turned on, said control unit is configured to actuate said power management function of said host computing device and to disable said power source, thereby turning off said host computing device.

3. The computer system as claimed in claim 1, wherein when said control unit receives the first command signal and determines that said host computing device is turned off and said power source is enabled, said control unit is configured to operate said switch unit in the first switch state.

4. The computer system as claimed in claim 1, wherein when said control unit receives the second command signal and determines that said host computing device is turned off and said power source is enabled, said control unit is configured to disable said power source, thereby turning off said audio-and-video reproducing device.

5. The computer system as claimed in claim 1, wherein said switch unit is an electrically controlled switch unit.

6. The computer system as claimed in claim 1, further comprising a push button unit coupled to said control unit and operable so as to generate the first or second command signal.

7. The computer system as claimed in claim 1, further comprising a remote controller operable so as to generate the first or second command signal, which is transmitted wirelessly to said control unit.

8. The computer system as claimed in claim 1, further comprising:
a display controller coupled to said host computing device and said audio-and-video reproducing device, adapted to be coupled to a display device, and operable so as to provide the video output signal generated by said host computing device to the display device when said switch unit is in the first switch state and when said power source is enabled, and so as to provide the video output signal generated by said audio-and-video reproducing device to the display device when said switch unit is in the second switch state and when said power source is enabled; and
an audio controller coupled to said host computing device and said audio-and-video reproducing device, adapted to be coupled to an audio device, and operable so as to provide the audio output signal generated by said host computing device to the audio device when said switch unit is in the first switch state and when said power source is enabled, and so as to provide the audio output signal generated by said audio-and-video reproducing device to the audio device when said switch unit is in the second switch state and when said power source is enabled.

9. The computer system as claimed in claim 1, wherein said reading device is one of a memory card reader and an optical disc drive.

10. The computer system as claimed in claim 1, further comprising a casing that houses said reading device, said power source, said host computing device, said audio-and-video reproducing device, said switch unit, and said control unit.

11. A computer system, comprising:
a reading device operable so as to read information from a storage medium;
a power source;
a host computing device having a power management function which when actuated causes said host computing device to operate in a soft-off state;
an audio-and-video reproducing device;
a switch unit coupled to said reading device, said power source, said host computing device, and said audio-and-video reproducing device, said switch unit being operable in a first switch state, where said switch unit connects said reading device and said power source to said host computing device and simultaneously disconnects said reading device and said power source from said audio-and-video reproducing device, and a second switch state, where said switch unit connects said reading device and said power source to said audio-and-video reproducing device and simultaneously disconnects said reading device and said power source from said host computing device,
wherein said host computing device is turned on and is operable so as to convert the information read by said reading device into audio and video output signals when said switch unit is in the first switch state and when said power source is enabled, and
wherein said audio-and-video reproducing device is turned on and is operable so as to convert the information read by said reading device into audio and video output signals when said switch unit is in the second switch state and when said power source is enabled; and
a control unit coupled to said power source, said host computing device, and said switch unit,
wherein when said control unit receives a first command signal and determines that said host computing device is turned off and said power source is disabled, said control unit is configured to operate said switch unit in the first switch state and to enable said power source,
wherein when said control unit receives a second command signal and determines that said host computing device is turned off and said power source is disabled, said control unit is configured to operate said switch unit in the second switch state and to enable said power source, and
wherein when said control unit receives the second command signal and determines that said host computing device is turned on, said control unit is configured to actuate said power management function of said host computing device and to operate said switch unit in the second switch state.

12. The computer system as claimed in claim 11, wherein when said control unit receives the first command signal and determines that said host computing device is turned on, said control unit is configured to actuate said power management function of said host computing device and to disable said power source, thereby turning off said host computing device.

13. The computer system as claimed in claim 11, wherein when said control unit receives the first command signal and determines that host computing device is turned off and said power source is enabled, said control unit is configured to operate said switch unit in the first switch state.

14. The computer system as claimed in claim 11, wherein when said control unit receives the second command signal and determines that said host computing device is turned off and said power source is enabled, said control unit is configured to disable said power source, thereby turning off said audio-and-video reproducing device.

15. The computer system as claimed in claim 11, further comprising a push button unit coupled to said control unit and operable so as to generate the first or second command signal.

16. The computer system as claimed in claim 11, further comprising:
a display controller coupled to said host computing device and said audio-and-video reproducing device, adapted to be coupled to a display device, and operable so as to provide the video output signal generated by said host computing device to the display device when said switch unit is in the first switch state and when said power source is enabled, and so as to provide the video output signal generated by said audio-and-video reproducing device to the display device when said switch unit is in the second switch state and when said power source is enabled; and
an audio controller coupled to said host computing device and said audio-and-video reproducing device, adapted to be coupled to an audio device, and operable so as to provide the audio output signal generated by said host computing device to the audio device when said switch unit is in the first switch state and when said power source is enabled, and so as to provide the audio output signal generated by said audio-and-video reproducing device to the audio device when said switch unit is in the second switch state and when said power source is enabled.

17. The computer system as claimed in claim 11, further comprising a casing that houses said reading device, said power source, said host computing device, said audio-and-video reproducing device, said switch unit, and said control unit.

18. A switching method for a computer system, the computer system including a reading device, a power source, a host computing device, an audio-and-video reproducing device, a switch unit, and a control unit, the switch unit being operable in a first switch state, where the switch unit connects the reading device and the power source to the host computing device and simultaneously disconnects the reading device and the power source from the audio-and-video reproducing device, and a second switch state, where the switch unit connects the reading device and the power source to the audio-and-video reproducing device and simultaneously disconnects the reading device and the power source from the host computing device, said switching method comprising:
A) configuring the control unit to determine whether a first command signal or a second command signal is received;
B) when it is determined in step A) that the first command signal is received, configuring the control unit to determine whether the host computing device is turned on or off;
C) when it is determined in step B) that the host computing device is turned off, configuring the control unit to determine whether the power source is enabled or disabled;
D) when it is determined in step C) that the power source is disabled, configuring the control unit to operate the switch unit in the first switch state and to enable the power source, wherein the host computing device is turned on and is operable so as to convert information read by the reading device into audio and video output signals when the switch unit is in the first switch state and when the power source is enabled;
E) when it is determined in step A) that the second command signal is received, configuring the control unit to determine whether the host computing device is turned on or off;
F) when it is determined in step E) that the host computing device is turned off, configuring the control unit to determine whether the power source is enabled or disabled;
G) when it is determined in step F) that the power source is disabled, configuring the control unit to operate the switch unit in the second switch state and to enable the power source, wherein the audio-and-video reproducing device is turned on and is operable so as to convert information read by the reading device into audio and video output signals when the switch unit is in the second switch state and when the power source is enabled; and
H) when it is determined in step E) that the host computing device is turned on, configuring the control unit to ignore the second command signal.

19. The switching method as claimed in claim 18, further comprising:
I) when it is determined in step B) that the host computing device is turned on, configuring the control unit to actuate a power management function of the host computing device, which causes the host computing device to operate in a soft-off state, and to disable the power source, thereby turning off the host computing device.

20. The switching method as claimed in claim 18, wherein when it is determined in step C) that the power source is enabled, configuring the control unit to operate the switch unit in the first switch state.

21. The switching method as claimed in claim 18, wherein when it is determined in step F) that the power source is enabled, configuring the control unit to disable the power source, thereby turning off the audio-and-video reproducing device.

22. A switching method for a computer system, the computer system including a reading device, a power source, a host computing device, an audio-and-video reproducing device, a switch unit, and a control unit, the switch unit being operable in a first switch state, where the switch unit connects the reading device and the power source to the host computing device and simultaneously disconnects the reading device and the power source from the audio-and-video reproducing device, and a second switch state, where the switch unit connects the reading device and the power source to the audio-and-video reproducing device and simultaneously disconnects the reading device and the power source from the host computing device, said switching method comprising:
A) configuring the control unit to determine whether a first command signal or a second command signal is received;
B) when it is determined in step A) that the first command signal is received, configuring the control unit to determine whether the host computing device is turned on or off;
C) when it is determined in step B) that the host computing device is turned off, configuring the control unit to determine whether the power source is enabled or disabled;
D) when it is determined in step C) that the power source is disabled, configuring the control unit to operate the switch unit in the first switch state and to enable the power source, wherein the host computing device is turned on and is operable so as to convert information read by the reading device into audio and video output signals when the switch unit is in the first switch state and when the power source is enabled;
E) when it is determined in step A) that the second command signal is received, configuring the control unit to determine whether the host computing device is turned on or off;
F) when it is determined in step E) that the host computing device is turned off, configuring the control unit to determine whether the power source is enabled or disabled;
G) when it is determined in step F) that the power source is disabled, configuring the control unit to operate the switch unit in the second switch state and to enable the power source, wherein the audio-and-video reproducing device is turned on and is operable so as to convert information read by the reading device into audio and video output signals when the switch unit is in the second switch state and when the power source is enabled; and
H) when it is determined in step E) that the host computing device is turned on, configuring the control unit to actuate a power management function of the host computing device, which causes the host computing device to operate in a soft-off state, and to operate the switch unit in the second switch state.

23. The switching method as claimed in claim 22, further comprising:
I) when it is determined in step B) that the host computing device is turned on, configuring the control unit to actuate the power management function of the host computing device and to disable the power source, thereby turning off the host computing device.

24. The switching method as claimed in claim 22, wherein when it is determined in step C) that the power source is enabled, configuring the control unit to operate the switch unit in the first switch state.

25. The switching method as claimed in claim 22, wherein when it is determined in step F) that the power source is enabled, configuring the control unit to disable the power source, thereby turning off the audio-and-video reproducing device.
